(19) United States
(12) Patent Application Publication
(10) Pub. No.: US 2018/0356925 A1
(43) Pub. Date: Dec. 13, 2018

(54) TOUCH SUBSTRATE, METHOD FOR FABRICATING THE SAME, TOUCH PANEL

(71) Applicant: BOE TECHNOLOGY GROUP CO., LTD., Beijing (CN)

(72) Inventors: Yudong LIU, Beijing (CN); Rongcheng LIU, Beijing (CN); Hui WANG, Beijing (CN); Ning WANG, Beijing (CN); Jian MA, Beijing (CN); Hailong LI, Beijing (CN)

(21) Appl. No.: 15/736,635

(22) PCT Filed: Mar. 2, 2017
(86) PCT No.: PCT/CN2017/075447

§ 371 Date: Dec. 14, 2017

(30) Foreign Application Priority Data
Jul. 1, 2016 (CN) 201610506366.5

(51) Int. Cl. G06F 3/041; G06F 3/044

(52) U.S. Cl. CPC G06F 3/0412; G02F 1/13338; G06F 3/044

(57) ABSTRACT

A touch substrate is disclosed, which comprises a substrate, an insulating layer, a first touch electrode, and a second touch electrode. The insulating layer is arranged on the substrate. The first and second touch electrodes are arranged on the substrate, have an overlapping region, and are insulated from each other in the overlapping region through the insulating layer. The substrate is provided with a first trench, in which the first touch electrode is at least partially arranged. By arranging the first touch electrode at least partially in the first trench, the difference in height due to the first touch electrode is reduced or eliminated, and adverse effects on films over the first touch electrode due to the difference in height are reduced or eliminated. A method for fabricating the touch substrate and a touch panel are also disclosed.

### RELATED APPLICATIONS

The present application claims the benefit of Chinese Patent Application No. 201610506366.5, filed on Jul. 1, 2016, the entire disclosure of which is incorporated herein by reference.

### TECHNICAL FIELD

The present disclosure relates to the field of display technology, and particularly to a touch substrate, a method for fabricating the same, and a touch panel.

### BACKGROUND

Due to advantages of accurate positioning, good sense of touch, a long lifetime, or the like, a capacitive touch panel has been applied widely in the field of touch control display. On basis of the arrangement of a touch substrate in the touch panel, the touch panel is generally divided into an OGS (One Glass Solution) touch panel, an On-Cell touch panel, and an In-Cell touch panel. In the OGS touch panel, the touch substrate in integrated onto a protection substrate (cover plate), and the protection substrate is attached onto a display panel. In the On-Cell touch panel, the touch substrate is arranged on an outer surface of a liquid crystal cell (Cell), for example, a surface of a color film substrate away from an array substrate. In the In-Cell touch panel, the touch substrate is arranged inside the liquid crystal cell, for example, between the color film substrate and a liquid crystal layer.

In the touch substrate, a touch control pattern may introduce a difference in height, which possibly causes defects in a films or wiring over the touch control pattern.

### SUMMARY

Embodiments of the present disclosure intend to provide an improved touch substrate, a method for fabricating the same, and a touch panel.

An embodiment of the present disclosure provides a touch substrate. The touch substrate comprises a substrate, an insulating layer, a first touch electrode, and a second touch electrode. The insulating layer is arranged on the substrate. The first touch electrode and the second touch electrode are arranged on the substrate and have an overlapping region. The first touch electrode and the second touch electrode are insulated from each other in the overlapping region through the insulating layer. The substrate is provided with a first trench. The first touch electrode is at least partially arranged in the first trench.

In the touch substrate of this embodiment, the first touch electrode is at least partially arranged in the first trench. As compared with the case in which the substrate is not provided with the first trench, the difference in height due to the first touch electrode is reduced or eliminated, and adverse effects on films over the first touch electrode due to the difference in height are reduced or eliminated. For example, this facilitates alleviating the breaking of films over the first touch electrode due to a large difference in height, and reducing difficulties and risks in a film forming process. This facilitates reducing defects of a wiring due to climbing over a slope, for example an open circuit of a wiring or a short circuit between wirings in different layers. Moreover, a small difference in height facilitates avoiding scratches and defects related with electro static discharge (ESD), thus improving yield.

In an embodiment of the present disclosure, the first touch electrode comprises at least one conductive connection part and a plurality of sub-electrodes which are separated from each other, two neighboring sub-electrodes are electrically connected with each other through one of the conductive connection parts, and the at least one conductive connection part is arranged in the overlapping region between the first touch electrode and the second touch electrode.

In the touch substrate of this embodiment, two neighboring sub-electrodes of the first touch electrode are electrically connected with each other through one conductive connection part, thus forming a bridge type first touch electrode, and accordingly forming a bridge type touch substrate.

In an embodiment of the present disclosure, the sub-electrode of the first touch electrode is at least partially arranged in the first trench.

In the touch substrate of this embodiment, the sub-electrode is at least partially arranged in the first trench. As compared with the case in which the substrate is not provided with the first trench, the difference in height due to the first touch electrode is reduced or eliminated, and adverse effects on films over the sub-electrode due to the difference in height are reduced or eliminated.

In an embodiment of the present disclosure, the substrate is further provided with a second trench, and the second touch electrode is at least partially arranged in the second trench.

In the touch substrate of this embodiment, the second touch electrode is at least partially arranged in the second trench. As compared with the case in which the substrate is not provided with the second trench, the difference in height resulting from the second touch electrode is reduced or eliminated, and adverse effects on films over the sub-electrode due to the difference in height are reduced or eliminated.

In an embodiment of the present disclosure, the plurality of sub-electrodes of the first touch electrode are arranged in a same layer as the second touch electrode.

In the touch substrate of this embodiment, the plurality of sub-electrodes of the first touch electrode are arranged in a same layer as the second touch electrode. It is understood that the expression “the plurality of sub-electrodes of the first touch electrode are arranged in a same layer as the second touch electrode” as used herein indicates that the plurality of sub-electrodes of the first touch electrode and the second touch electrode are made from a same film. Although they are arranged in a same layer as far as the stacking order is concerned, this does not indicate that they are spaced apart from the substrate by a same distance. This facilitates simplifying the process for the plurality of sub-electrodes of the first touch electrode and the second touch electrode. For example, the sub-electrodes and the second touch electrode can be formed by a same filming process and a same patterning process.

In an embodiment of the present disclosure, the first trench has a depth which is no less than a thickness of the plurality of sub-electrodes of the first touch electrode.

In the touch substrate of this embodiment, the first trench has a depth no less than the thickness of the sub-electrodes, so that the first trench eliminates the difference in height resulting from the sub-electrodes, and thus eliminates adverse effects on films over the sub-electrode due to the difference in height.

In an embodiment of the present disclosure, the second trench has a depth which is no less than a sum of a thickness of the second touch electrode and a thickness of the insulating layer.

In the touch substrate of this embodiment, the second trench has a depth no less than the sum of the thickness of the sub-electrodes and the thickness of the insulating layer, so that the second trench eliminates the difference in height due to the sub-electrodes and the insulating layer, and thus eliminates adverse effects on films over the sub-electrode and insulating layer due to the difference in height.

In an embodiment of the present disclosure, the first trench and the second trench have a same depth.

In the touch substrate of this embodiment, the first trench and the second trench have a same depth, and are formed by in a same process step. This facilitates simplifying the process for forming the first trench and the second trench.

In an embodiment of the present disclosure, the first trench is at least arranged in the overlapping region between the first touch electrode and the second touch electrode. In another embodiment of the present disclosure, the second trench is at least arranged in the overlapping region between the first touch electrode and the second touch electrode.

In the touch substrate of these embodiments, the first trench or the second trench is at least arranged in the overlapping region between the first touch electrode and the second touch electrode. Especially in a bridge type touch substrate, there is a significant difference in height at a bridge point of the touch control pattern, the insulating layer, and a metal connecting member. Since the first trench or the second trench is at least arranged in the overlapping region between the first touch electrode and the second touch electrode, i.e., the bridge point, this significantly reduces the difference in height at the bridge point, and thus significantly reduces or eliminates the risk that the difference in height introduces defects.

In an embodiment of the present disclosure, the conductive connection part of the first touch electrode is at least partially arranged in the first trench.

In the touch substrate of this embodiment, the conductive connection part is at least partially arranged in the first trench. As compared with the case in which the substrate is not provided with the first trench, the difference in height due to the conductive connection part is reduced or eliminated, and adverse effects on films over the conductive connection part due to the difference in height are reduced or eliminated.

In an embodiment of the present disclosure, the first trench has a depth which is no less than a thickness of the conductive connection part of the first touch electrode.

In the touch substrate of this embodiment, the first trench has a depth no less than the thickness of the conductive connection part, so that the first trench eliminates the difference in height due to the conductive connection part, and thus eliminates adverse effects on films over the conductive connection part due to the difference in height.

In an embodiment of the present disclosure, the first trench has a depth which is no less than a sum of a thickness of the conductive connection part of the first touch electrode and a thickness of the insulating layer.

In the touch substrate of this embodiment, the first trench has a depth no less than the sum of the thickness of the conductive connection part and the thickness of the insulating layer, so that the first trench eliminates the difference in height due to the conductive connection part and the insulating layer, and thus eliminates adverse effects on films over the conductive connection part and the insulating layer due to the difference in height.

In an embodiment of the present disclosure, the first touch electrode and the second touch electrode comprise a transparent electrically conductive material, and the insulating layer comprises a transparent insulating material.

In the touch substrate of this embodiment, the first touch electrode and the second touch electrode comprises a transparent electrically conductive material, for example a metal, a metal alloy, a metal oxide, carbon nanotube, and graphene. The insulating layer comprises a transparent insulating material, for example, an inorganic material like Silicon Oxide (SiO₂), Silicon Nitride (SiNₓ) and Silicon Oxynitride (SiOₓN_{y}), or an organic material like resin.

An embodiment of the present disclosure provides a touch panel, comprising a first display substrate, a second display substrate, and a protection substrate which is arranged on a side of the second display substrate away from the first display substrate. One of the second display substrate and the protection substrate comprise the touch substrate as described above.

In the touch panel of this embodiment, the first display substrate for example is an array substrate, and the second display substrate is a color film substrate. In an embodiment, the first display substrate is a Color Filter on Array (COA) substrate, and the second display substrate is a counter substrate.

In an embodiment of the present disclosure, the touch substrate is arranged on a side of the protection substrate close to the second display substrate. The touch substrate is integrated onto the protection substrate, and a surface of the protection substrate on which the touch substrate is provided faces a display module consisting of the first display substrate and the second display substrate. Namely, the touch panel is an OGS touch panel.

In an embodiment of the present disclosure, the touch substrate is arranged on a side of the second display substrate away from the first display substrate. The touch substrate is arranged on a side of the second display substrate away from the first display substrate. Namely, the touch panel is an On-Cell touch panel.

In an embodiment of the present disclosure, the touch substrate is arranged on a side of the second display substrate close to the first display substrate. The touch substrate is arranged on a side of the second display substrate close to the first display substrate. Namely, the touch panel is an In-Cell touch panel.

The touch panel in this embodiment of the present disclosure has same or similar beneficial effects as embodiments for the touch substrate as described above, which are not repeated here.

An embodiment of the present disclosure provides a method for fabricating a touch substrate, comprising steps of: forming a trench in a substrate; forming a first touch electrode and an insulating material pattern on the substrate in this order, wherein the first touch electrode is at least partially arranged in the trench; and forming a second touch electrode on the substrate, wherein the first touch electrode and the second touch electrode have an overlapping region and are insulated from each other in the overlapping region through the insulating material pattern.

In an embodiment of the present disclosure, the step of forming the trench in the substrate comprises: coating photoresist on the substrate, forming a photoresist pattern by exposure and development; and by using the photoresist pattern as a mask, forming the trench in the substrate by dry etching.

In an embodiment of the present disclosure, the step of forming the first touch electrode and the insulating material pattern on the substrate in this order comprises: forming an electrically conductive layer and an insulating layer on the substrate in this order; patterning the insulating layer to form the insulating material pattern; and removing the photoresist pattern and the electrically conductive layer on the photoresist pattern by using a peeling solution, to form the first touch electrode.

In the method of the above embodiments, due to the application of lifting off, a dry etching process is added in an early stage of the process. However, the process for subsequently removing the photoresist and electrically conductive layer can be simplified. In this case, a complicated process is avoided in which different etching and development solutions are used for different films, and this reduces cost and tact time.

It is understood that the above general description and the following detailed description are merely illustrative and explanatory, and do not intend to limit the present disclosure in any manner.

### BRIEF DESCRIPTION OF THE DRAWINGS

In order to explain the technical solutions in the embodiments of the present disclosure or the prior art more clearly, the drawings to be used in the description of the embodiments or the prior art will be introduced briefly in the following. Apparently, the drawings described below are only some embodiments of the present disclosure.

FIG. 1A is a top view for illustrating a bridge type touch substrate;

FIG. 1B is a cross-sectional view along line A-B in FIG. 1A;

FIG. 2A is a top view for illustrating a touch substrate in an embodiment of the present disclosure;

FIG. 2B is a cross-sectional view along line C-D in FIG. 2A;

FIG. 2C is another cross-sectional view along line C-D in FIG. 2A;

FIG. 3A is a top view for illustrating a touch substrate in an embodiment of the present disclosure;

FIG. 3B is a cross-sectional view along line E-F in FIG. 3A;

FIG. 4A is a top view for illustrating a touch substrate in an embodiment of the present disclosure;

FIG. 4B is a cross-sectional view along line G-H in FIG. 4A;

FIG. 5A is a cross-sectional view for illustrating a touch panel in an embodiment of the present disclosure;

FIG. 5B is a cross-sectional view for illustrating a touch panel in an embodiment of the present disclosure;

FIG. 5C is a cross-sectional view for illustrating a touch panel in an embodiment of the present disclosure;

FIG. 6 is a flow chart for illustrating a method for fabricating a touch substrate in an embodiment of the present disclosure; and

FIG. 7A, 7B, 7C, 7D, 7E, 7F and 7G are cross-sectional views for illustrating a touch substrate at stages of a method for fabricating the same in an embodiment of the present disclosure.

These drawings and verbal description do not intend to limit the scope of the present inventive concept, but to convey the present inventive concept to the person with ordinary skill in the art with reference to specific embodiments.

### DETAILED DESCRIPTION OF EMBODIMENTS

To make the objects, the technical solutions and the advantages of embodiments of the present disclosure more apparent, the technical solutions of the embodiments of the present disclosure will be described in detail hereinafter in conjunction with the drawings of the embodiments of the present disclosure.

Reference numerals: 100, 200, 300, 700 substrate; 110, 210, 310, 410, 710 first touch electrode; 112, 212, 312, 712 sub-electrodes of first touch electrode; 114, 214, 314, 714 conductive connection part of first touch electrode; 120, 220, 320, 420, 720 second touch electrode; 130, 230, 330, 430, 730 insulating layer; 140, 240, 340, 440 passivation layer; 204, 304, 404, 704 first trench; 206, 706 second trench; 510 first display substrate; 515 liquid crystal layer; 520 second display substrate; 525 adhesive; 530 protection substrate; 702 photoresist; 708 electrically conducting material layer.

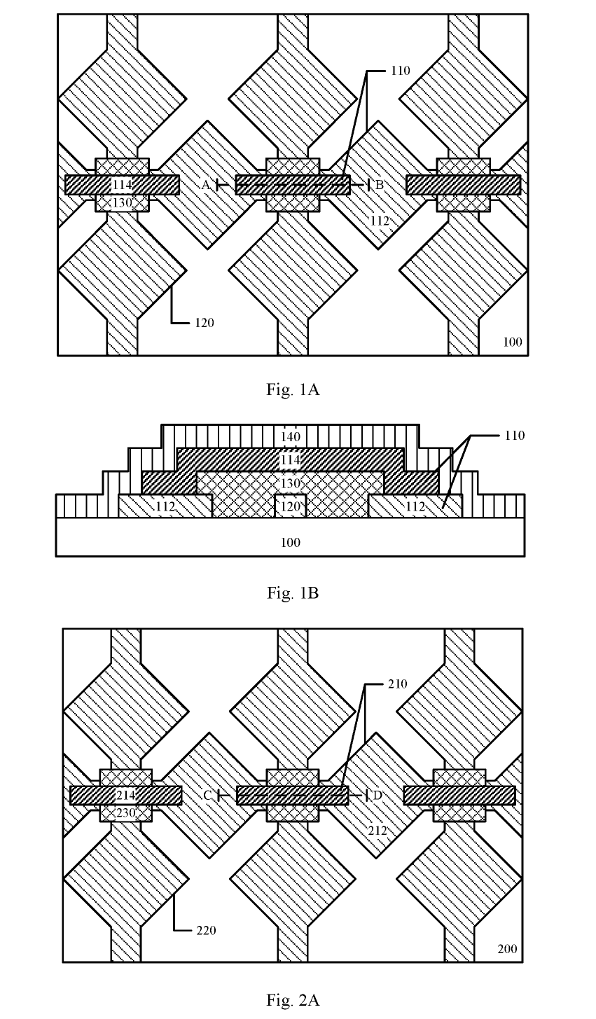

In a capacitive touch screen, a bridge type touch substrate is commonly applied. FIG. 1A is a top view for a bridge type touch substrate, and FIG. 1B is a cross-sectional view along line A-B in FIG. 1A. As shown, the touch substrate comprises a plurality of first touch electrodes 110 (only one of the first touch electrodes is shown in the figure) and a plurality of second touch electrodes 120 which are arranged on a substrate 100 and intersect with one another. Each first touch electrode 110 and each second touch electrode 120 are electrically connected to a touch control chip (not shown) through a wiring. Each first touch electrode 110 comprises a plurality of sub-electrodes 112. Neighboring sub-electrodes 112 are electrically connected with each other through a conductive connection part 114, so as to form the first touch electrode 110. Each first touch electrode 110 and each second touch electrode 120 are insulated from each other in the overlapping region through the insulating layer 130. The touch substrate further comprises a passivation layer (PVX) 140 which covers each first touch electrode 110 and each second touch electrode 120.

In a conventional OGS touch screen, the touch substrate is formed in the following manner. An electrically conducting material layer is deposited on a substrate like glass, a touch control pattern is formed by photolithography and etching, and then an insulating layer, a metal connecting member and a passivation layer are formed to form the touch substrate. The inventor has found that, a relatively difference in height appears at bridge points in the touch substrate where three patterned layers like the touch control pattern, the insulating layer, and the metal connecting member intersect. This prone to cause defects in films and wirings over the bridge point. Especially when the insulating layer is relatively thick, during fabricating the metal connecting member, metal layers over these bridge points suffer from process defect, and are subject to scratches and ESD defects. Therefore, reducing the difference in height at bridge points will provide positive impact for improving yield.

In the touch substrate of a conventional touch screen, the touch control pattern is realized in the following manner. An electrically conducting material layer is deposited on a substrate, and a photoresist pattern is formed by photolithography and development. By taking the photoresist pattern as a mask, the exposed electrically conductive material is removed by wet etching to form a touch control pattern. Then, an insulating layer is formed at bridge points. The inventor has found that, in this method for fabricating the insulating layer, an additional photolithography and development process is introduced, so that the cost increases.

Embodiments of a touch substrate, a method for fabricating the same, and a touch panel will be described hereinafter with reference to the drawings.

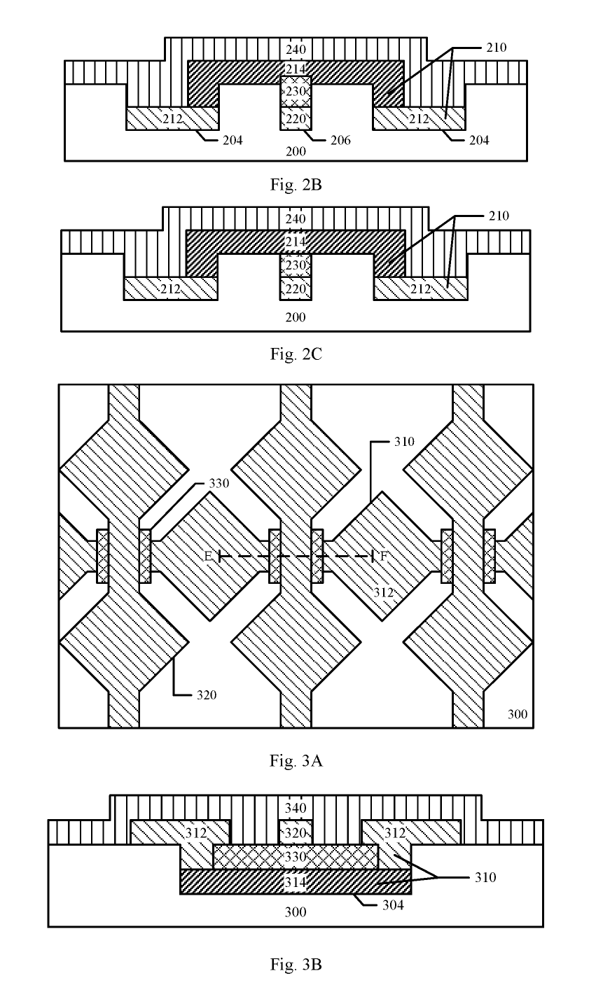

An embodiment of the present disclosure provides a touch substrate. As shown in FIG. 2A, the touch substrate comprises a substrate 200 and an insulating layer 230 which is arranged on the substrate 200, a plurality of first touch electrodes 210 (only one of which is shown), and plurality of second touch electrodes 220. The first touch electrodes 210 and the second touch electrodes 220 have an overlapping region, and are insulated from each other in the overlapping region through the insulating layer 230.

Each first touch electrode 210 comprises at least one conductive connection part 214 and a plurality of sub-electrodes 212 which are separated from each other. Two neighboring sub-electrodes 212 are electrically connected with each other through one conductive connection part 214 to form the first touch electrode 210, thus forming a bridge type touch substrate. The conductive connection part 214 is arranged in the overlapping region between the first touch electrode 210 and the second touch electrode 220.

FIG. 2B is a cross-sectional view along line C-D in FIG. 2A. The substrate 200 is provided with a first trench 204. The first trench 204 has a pattern which at least partially matches a pattern of the first touch electrode 210. The first touch electrode 210 is at least partially arranged in the first trench 204. The expression “the first touch electrode 210 is at least partially arranged in the first trench 204” as used herein indicates that a partial or total thickness of the first touch electrode 210 is accommodated in the first trench 204.

In an exemplary embodiment, the first trench 204 has a pattern which matches a pattern of sub-electrodes 212 of the first touch electrode 210. The term “match” as used herein indicates that the first trench 204 and the sub-electrodes 212 have the identical cross-sectional shape at a corresponding depth. As shown in FIG. 2B, the sub-electrodes 212 of the first touch electrode 210 are at least partially arranged in the first trench 204. The expression “the sub-electrodes 212 of the first touch electrode 210 are at least partially arranged in the first trench 204” as used herein indicates that a partial or total thickness of the sub-electrodes 212 is accommodated in the first trench 204.

In an exemplary embodiment, the first trench 204 has a depth which is no less than a thickness of the plurality of sub-electrodes 212 of the first touch electrode 210. In this way, the first trench 204 eliminates difference in height due to the sub-electrodes 212, and thus eliminates adverse effects on films over the sub-electrodes 212 due to difference in height.

As shown in FIG. 2B, the substrate 200 is further provided with a second trench 206. The second trench 206 has a pattern which matches a pattern of the second touch electrode 220. The second touch electrode 220 is at least partially arranged in the second trench 206. In an exemplary embodiment, a partial or total thickness of the second touch electrode 220 is accommodated in the second trench 206. It is noted that although the first trench 204 and the second trench 206 shown in FIG. 2B have a same depth, in other embodiments, the first trench 204 and the second trench 206 may have different depths. In case the first trench 204 and the second trench 206 have a same depth, they may be formed in a same process step, which simplifies process steps.

In the touch substrate shown in FIG. 2B, the first trench 204 has a depth larger than a thickness of the sub-electrodes 212. Moreover, the second trench 206 has a depth larger than a thickness of the second touch electrode 220, but smaller than a sum of the thickness of the second touch electrode 220 and a thickness of the insulating layer 230.

In an exemplary embodiment, the plurality of sub-electrodes 212 of the first touch electrode 210 and the second touch electrode 220 are arranged in a same layer. The expression “arranged in a same layer” as used herein indicates that the plurality of sub-electrodes 212 and the second touch electrode 220 are made from a same film. For example, an electrically conducting material layer is firstly formed, and then a patterning process is performed on the electrically conducting material layer, to form the sub-electrodes 212 and the second touch electrode 220 at the same time.

It is noted that the patterning process comprises a process of forming a predefined pattern with a mask plate. For example, the patterning process comprises coating photoresist, exposure, development, etching, peeling photoresist, or the like. However, the patterning process is not limited to this, and other processes capable of forming a predefined pattern can also be applied.

In an exemplary embodiment, the second trench 206 has a depth which is no less than a sum of a thickness of the second touch electrode 220 and a thickness of the insulating layer 230. In this way, the second trench 206 eliminates difference in height due to the second touch electrode 220 and the insulating layer 230, and thus eliminates adverse effects on films over the second touch electrode 220 and the insulating layer 230 due to difference in height. FIG. 2C is another cross-sectional view along line C-D in FIG. 2A. As shown in FIG. 2C, the second trench 206 has a depth equal to a sum of a thickness of the second touch electrode 220 and a thickness of the insulating layer 230. In this case, a surface of the insulating layer 230 is flush with a surface of the substrate 200, so that the conductive connection part 214 and a passivation layer 240 over the insulating layer 230 do not suffer from adverse effects due to difference in height.

In the exemplary embodiments shown in FIG. 2A, FIG. 2B, and FIG. 2C, the sub-electrodes 212 of the first touch electrode 210 and the second touch electrode 220 are arranged a side of the conductive connection part 214 close to the substrate 200. However, embodiments of the present disclosure are not limited to this. In other embodiments, the sub-electrodes of the first touch electrode and the second touch electrode are arranged on a side of the conductive connection part away from the substrate, as described hereinafter with reference to FIG. 3A and FIG. 3B.

FIG. 3A is a top view for a touch substrate in an embodiment of the present disclosure, and FIG. 3B is a cross-sectional view along line E-F in FIG. 3A. As shown, the touch substrate comprises a substrate 300 and an insulating layer 330 which is arranged on the substrate 300, a first touch electrode 310, and a second touch electrode 320. The first touch electrode 310 and the second touch electrode 320 have an overlapping region, and are insulated from each other in the overlapping region through the insulating layer 330. The first touch electrode 310 comprises a plurality of sub-electrodes 312 which are separated from each other and at least one conductive connection part 314. Any two neighboring sub-electrodes 312 are electrically connected with each other through one conductive connection part 314 to form the first touch electrode 310, thus forming a bridge type touch substrate.

In contrast with embodiments in FIG. 2A, FIG. 2B and FIG. 2C, in the touch substrate shown in FIG. 3A and FIG. 3B, the sub-electrodes 312 of the first touch electrode 310 and the second touch electrode 320 are arranged on a side of the conductive connection part 314 away from the substrate 300.

As shown in FIG. 3B, the substrate 300 is provided with a first trench 304. The first trench 304 has a pattern which matches a pattern of the conductive connection part 314. The conductive connection part 314 is at least partially arranged in the first trench 304. In an exemplary embodiment, a partial or total thickness of the conductive connection part 314 is accommodated in the first trench 304.

In an exemplary embodiment, the first trench 304 has a depth which is no less than a thickness of the conductive connection part 314. In this way, the first trench 304 eliminates difference in height due to the conductive connection part 314, and thus eliminates adverse effects on films over the conductive connection part 314 due to difference in height.

In an exemplary embodiment, the first trench 304 has a depth which is no less than a sum of a thickness of the conductive connection part 314 and a thickness of the insulating layer 330. In this way, the first trench 304 eliminates difference in height due to the conductive connection part 314 and the insulating layer 330, and thus eliminates adverse effects on films over the conductive connection part 314 and the insulating layer 330 due to difference in height.

As shown in FIG. 3B, the first trench 304 has a depth equal to a sum of a thickness of the conductive connection part 314 and a thickness of the insulating layer 330. In this case, a surface of the insulating layer 330 is flush with a surface of the substrate 300, so that the sub-electrodes 312 and the second touch electrode 320 over the insulating layer 330 do not suffer from adverse effects due to difference in height.

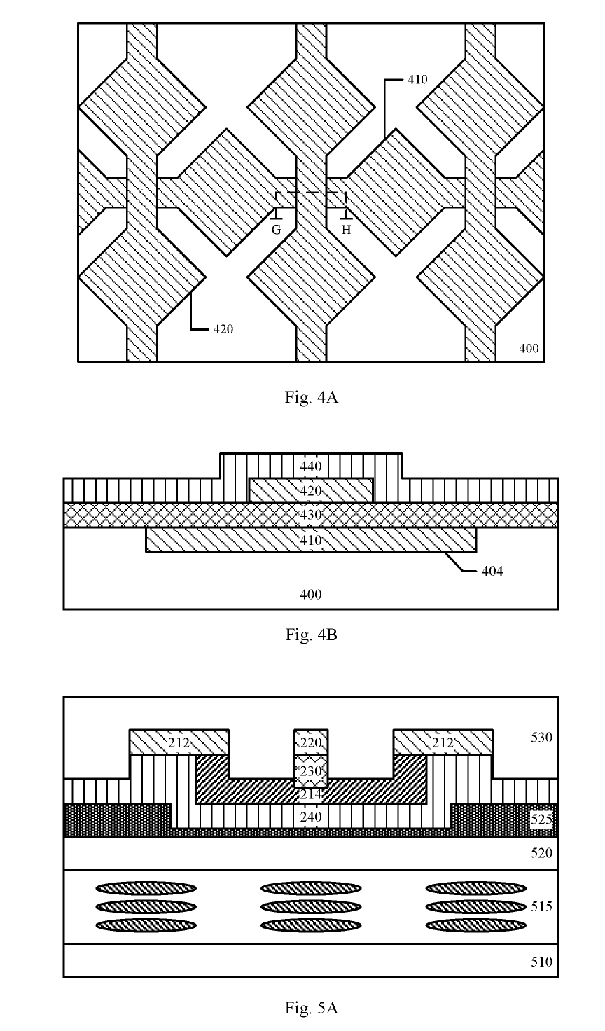

FIG. 4A is a top view for a touch substrate in an embodiment of the present disclosure, and FIG. 4B is a cross-sectional view along line G-H in FIG. 4A. As shown, the touch substrate comprises a substrate 400 and an insulating layer 430 which is arranged on the substrate 400, a first touch electrode 410, and a second touch electrode 420. The first touch electrode 410 and the second touch electrode 420 have an overlapping region, and are insulated from each other in the overlapping region through the insulating layer 430. As shown in FIG. 4B, the substrate 400 is provided with a first trench 404. The first trench 404 is at least arranged in the overlapping region between the first touch electrode 410 and the second touch electrode 420. The first trench 404 has a pattern which matches a pattern of the first touch electrode 410. The first touch electrode 410 is at least partially arranged in the first trench 404. In an exemplary embodiment, a partial or total thickness of the first touch electrode 410 is accommodated in the first trench 404. In this embodiment, the first touch electrode 410 and the second touch electrode 420 are arranged in different layers, and are insulated from each other through the insulating layer 430. It will be appreciated by the person with ordinary skill in the art that the second touch electrode 420 may adopt a bridge type structure, e.g., the bridge type structure as described with reference to the first touch electrode 210 in FIGS. 2B, 2C.

In an exemplary embodiment, the first touch electrode 210, 310, 410 and the second touch electrode 220, 320, 420 comprise a transparent electrically conductive material, and the insulating layer 230, 330, 430 comprises a transparent insulating material.

In an exemplary embodiment, the first touch electrode 210, 310, 410 and the second touch electrode 220, 320, 420 comprises a metal, a metal alloy, a metal oxide, carbon nanotube or graphene.

In an exemplary embodiment, the sub-electrodes 212, 312 of the first touch electrode 210, 310 and the second touch electrode 220, 320, 420 comprises an electrically conductive metal oxide, such as Indium Tin Oxide (ITO), Indium Zinc Oxide (IZO), Indium Gallium Zinc Oxide (IGZO). These electrically conductive metal oxides have a superior light transmission property over metal or metal alloy, which facilitates improving the light transmittance and blanking effect of the touch substrate.

In an exemplary embodiment, the conductive connection part 214, 314 of first touch electrode 210, 310 comprises a transparent metal or metal alloy. These metals or metal alloys have superior electrically conductivity over metal oxides, which facilitates reducing resistance of the first touch electrode 210, 310 and improving sensitivity of the first touch electrode 210, 310.

In an exemplary embodiment, the conductive connection part 214, 314 of the first touch electrode 210, 310 comprises molybdenum, aluminum, molybdenum alloy or aluminum alloy. These metals or metal alloys has good stability, and is resistant to oxidation or erosion. In this case, the conductive connection part 214, 314 has good stability, which facilitates improving the performance and lifetime of the touch substrate.

In an exemplary embodiment, the insulating layer 230, 330, 430 comprises an inorganic material like Silicon Oxide (SiO₂), Silicon Nitride (SiNₓ), Silicon Oxynitride (SiOₓN_{y}), or an organic material like resin.

In an exemplary embodiment, as shown in FIG. 2B, FIG. 2C, FIG. 3B and FIG. 4B, the touch substrate further comprises the passivation layer 240, 340, 440, which covers the first touch electrode and the second touch electrode, to prevent the first touch electrode and second touch electrode from external influence. In an exemplary embodiment, the passivation layer 240, 340, 440 is made from a transparent material, and the transparent material is the same as the material for the insulating layer 230, 330, 430 as described above. In an exemplary embodiment, the passivation layer 240, 340, 440 comprises an inorganic material like Silicon Oxide (SiO₂), Silicon Nitride (SiNₓ), Silicon Oxynitride (SiOₓN_{y}), or an organic material like resin.

It is noted that description is made in the above embodiments by taking a bridge type touch substrate as an example. However, in embodiments of the present disclosure, a touch substrate of other than an electrically conductive bridge type as known for the person with ordinary skill in the art can also be adopted, provided that an insulating layer is arranged between the first touch electrode and the second touch electrode in an overlapping region therebetween and insulates the first touch electrode and the second touch electrode from each other.

It is noted that in the touch substrate according to embodiments of the present disclosure, the first touch electrode and the second touch electrode are not limited to the pattern shown in FIG. 2A, FIG. 3A and FIG. 4A, and other patterns known by the person with ordinary skill in the art are also possible.

It is noted that the touch substrate according to embodiments of the present disclosure may operate under the principle of self-capacitance. Namely, each of the first touch electrode and the second touch electrode is an individual self-capacitance electrode. Of course, the touch substrate may operate under the principle of mutual-capacitance. Namely, one of the first touch electrode and the second touch electrode acts as a touch control sense electrode and the other acts as a touch control drive electrode.

Embodiments of the present disclosure further provide a touch panel, comprising the touch substrate the above embodiments. As shown in FIG. 5A, FIG. 5B, and FIG. 5C, the touch panel comprises a first display substrate 510, a second display substrate 520, and a protection substrate 530. The protection substrate 530 is arranged on a side of the second display substrate 520 away from the first display substrate 510. As shown in FIG. 5A, the touch substrate is arranged on a side of the protection substrate 530 close to the second display substrate 520, and the touch panel is an OGS touch panel. As shown in FIG. 5B, the touch substrate is arranged on a side of the second display substrate 520 away from the first display substrate 510, and the touch panel is an On-Cell touch panel. As shown in FIG. 5C, the touch substrate is arranged on a side of the second display substrate 520 close to the first display substrate 510, and the touch panel is an In-Cell touch panel. The touch substrate is the touch substrate in any one of the above embodiments.

In an exemplary embodiment, the first display substrate 510 is an array substrate, and the second display substrate 520 is a color film substrate. A liquid crystal layer 515 is sandwiched between the first display substrate 510 and the second display substrate 520, thus forming a liquid crystal display module.

The protection substrate 530 is fixed to the second display substrate 520 by means of an adhesive 525. In an exemplary embodiment, the protection substrate 530 is fixed at a peripheral area to the second display substrate 520 by means of a double faced adhesive tape. Alternatively, the protection substrate 530 is seamlessly attached to the second display substrate 520 by means of water gel or optical cement.

It is noted that in the above embodiments reference is made to the OGS, On-Cell and In-Cell touch panel. However, the touch panel can also be other types of touch panel known by the person with ordinary skill in the art. For example, the touch substrate is arranged on glass or resin, the touch substrate is attached to an outer surface of the liquid crystal display module, and the protection substrate is attached on a side of the touch substrate away from the liquid crystal display module.

It is noted that in the above embodiments reference is made to a liquid crystal display module. However, the touch panel can also adopt other display modules known by the person with ordinary skill in the art, for example an organic light emitting display device (OLED).

It is noted that in the above embodiments the touch panel is explained with reference to the touch substrate shown in FIG. 2B. However, the touch panel can also adopt the touch substrate shown in FIG. 2C, FIG. 3B, and FIG. 4B.

Reference numerals in FIG. 5A, FIG. 5B, and FIG. 5C are identical with those for the touch substrate of the above embodiments, and are not repeated here.

The touch panel of the above embodiments can be applied to various display devices, for example, any product or component with a display function like a mobile phone, tablet computer, TV, monitor, notebook computer, digital photo frame, navigator, electronic paper, or the like.

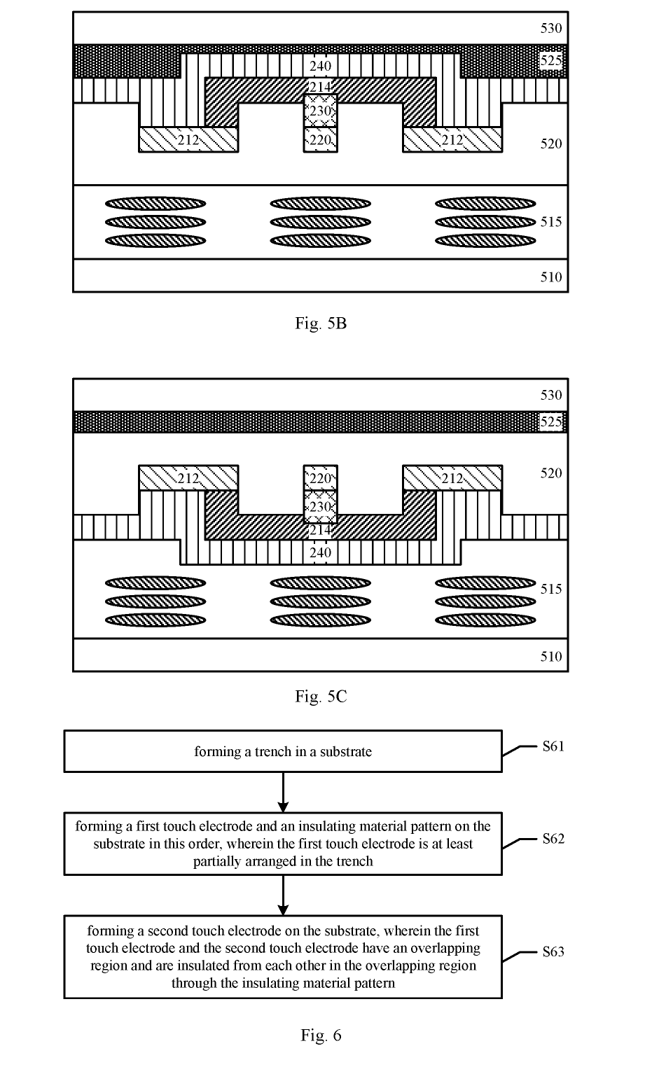

An embodiment of the present disclosure provides a method for fabricating a touch substrate. As shown in FIG. 6, the method comprises steps of: S61, forming a trench in a substrate; S62, forming a first touch electrode and an insulating material pattern on the substrate in this order, wherein the first touch electrode is at least partially arranged in the trench; and S63, forming a second touch electrode on the substrate, wherein the first touch electrode and the second touch electrode have an overlapping region and are insulated from each other in the overlapping region through the insulating material pattern.

In an embodiment of the present disclosure, the step S61 comprises: coating photoresist on the substrate, forming a photoresist pattern by exposure and development; and by using the photoresist pattern as a mask, forming the trench in the substrate by dry etching.

In an embodiment of the present disclosure, the step S62 comprises: forming an electrically conductive layer and an insulating layer on the substrate in this order; patterning the insulating layer to form the insulating material pattern; and removing the photoresist pattern and the electrically conductive layer on the photoresist pattern by using a peeling solution, to form the first touch electrode.

In the method of embodiments of the present disclosure, there is no limitation for the order of forming the first touch electrode, the second touch electrode, and the insulating layer, provided that the first touch electrode and the second touch electrode have an overlapping region and are insulated from each other by the insulating layer.

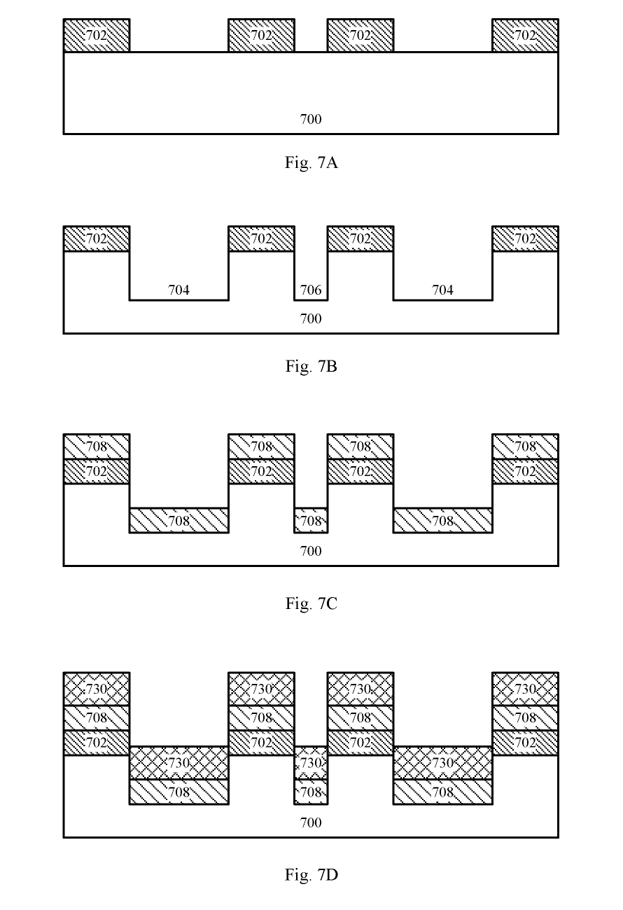

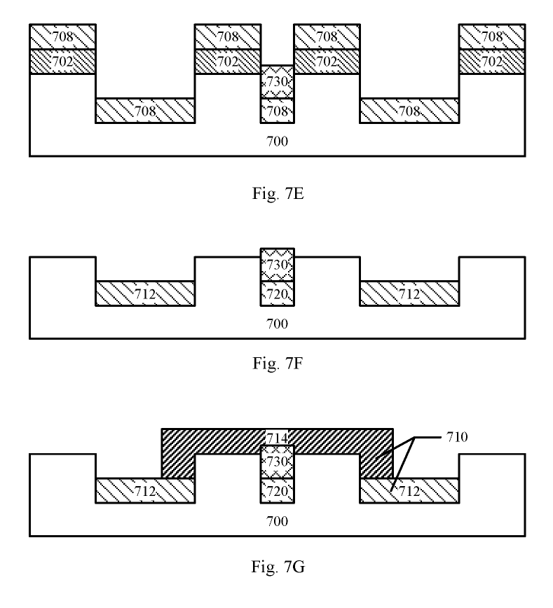

For example, as for the touch substrate shown in FIGS. 2A, 2B, and 2C, the method according to an embodiment of the present disclosure comprises steps of S71, S72, S73, S74, S75, S76, and S77. These steps will be described in detail hereinafter with reference to FIG. 7A, 7B, 7C, 7D, 7E, 7F and 7G.

Step S71: photoresist is coated on a substrate 700, and a desired pattern of photoresist 702 is formed by exposure and development, as shown in FIG. 7A.

Step S72: by using the pattern of photoresist 702 of step S71 as a mask, a first trench 704 and a second trench 706 are formed in the substrate 700 by etching, as shown in FIG. 7B.

In this step, for example, a dry etching technique such as reactive ion etching (ME) is applied for etching the substrate 700. Process parameters of RIE are optimized to realize a high etching selectivity, the first trench 704 and the second trench 706 are etched to a the required depth for partially accommodating sub-electrodes of the first touch electrode and the second touch electrode, at the expense that the pattern of photoresist 702 is partially etched away.

It is understood that the dry etching technique in this step is not limited to ME. For example, the dry etching technique may adopt ion beam milling, plasma etching, high pressure plasma (HPP) etching, high density plasma (HDP) etching, and inductively coupled plasma (ICP) etching.

Step S73: a transparent electrically conducting material layer 708 is formed on the structure resulting from step S72, as shown in FIG. 7C.

In this step, the electrically conducting material layer 708 such as ITO is formed by a film forming technique such as sputtering, evaporation, deposition, and coating.

Step S74: a transparent insulating layer 730 is formed on the structure resulting from step S73, as shown in FIG. 7D.

In this step, the insulating layer 730 is formed by a film forming technique such as sputtering, evaporation, deposition, and coating.

In steps S73 and S74, the film forming direction of the electrically conducting material layer 708 and the insulating layer 730 is controlled. In an ideal state, the precursor material for film is deposited on the substrate 700 in a direction perpendicular with the substrate 700, so as to avoid deposition on sidewalls of the pattern of photoresist 702.

Step S75: the insulating layer 730 in the first trench 704 and in a region of the substrate 700 which is not etched is removed by a process comprising applying photoresist, exposure, development, etching and peeling photoresist, and only the insulating layer 730 in the second trench 706 is retained, as shown in FIG. 7E.

Step S76: the structure resulting from step S75 is subject to lifting off. A proper peeling solution is used to remove the pattern of photoresist 702 and the electrically conducting material layer 708 on the pattern of photoresist 702, as shown in FIG. 7F.

In steps S71-75, the thickness of the pattern of photoresist 702 and the thickness of the insulating layer 730 are controlled accurately, to ensure that the pattern of photoresist 702 is not shielded by the insulating layer 730 in step S76, and that the pattern of photoresist 702 is removed smoothly. Moreover, in the etching process of the insulating layer 730 in step S75, it is favorable that variation in the etching depth is small.

By steps S71-76, sub-electrodes 712 are embedded in the first trench 704 of the substrate 700, and a second touch electrode 720 and the insulating layer 730 are embedded in the second trench 706 of the substrate 700, thus realizing an embedded touch control pattern in the substrate.

Step S77: a conductive connection part 714 is formed on the structure resulting from step S76 to electrically connect two neighboring sub-electrodes 712 and thus form a first touch electrode 710, by a process comprising forming an electrically conducting material layer, applying photoresist, exposure, development, etching, and peeling photoresist, as shown in FIG. 7G.

In the method of the above embodiment, a lifting off is performed. After the electrically conducting material layer 708 of e.g. ITO and the insulating layer 730 are formed in this order, the patterning process is performed for only one time, so that the insulating layer 730 in the selected region is removed, and the photoresist 702 as well as the electrically conducting material layer 708 thereon are peeled. In this way, the second touch electrode 720 and the insulating layer 730 thereon, i.e., the first two layers at the bridge point, are formed. Then, the conductive connection part 714 of e.g., a metal and an optional passivation layer are formed, thus completing the fabrication of the touch substrate.

In the above embodiments, the method has been described by referring to a case in which sub-electrodes 712 of the first touch electrode 710 and the second touch electrode 720 are made from ITO. However, the method is not limited to this. In this method, due to the application of lifting off, a dry etching process is added in an early stage of the process. However, the process for subsequently removing the photoresist and ITO layer can be simplified. In this case, a complicated process is avoided in which different etching and development solutions are used for different films, and this reduces cost and tact time.

As compared with the case in which the substrate is not provided with a trench, the touch substrate is relatively flat, the difference in height due to the touch substrate is reduced or eliminated, and adverse effects on films over the touch substrate due to the difference in height are reduced or eliminated. For example, this facilitates alleviating the breaking of films over the first touch electrode due to a large difference in height, and reducing difficulties and risks in a film forming process. This facilitates reducing defects of a wiring due to climbing over a slope, for example an open circuit of a wiring or a short circuit between wirings in different layers. Moreover, a small difference in height facilitates avoiding scratches and defects related with electro static discharge (ESD), thus improving yield.

As for the touch substrate shown in FIGS. 3A-3B, 4A-4B, the method for fabricating the touch substrate comprises steps which are similar with those described with reference to FIGS. 7A-7G, and thus are not repeated here.

Embodiments of the present disclosure disclose a touch substrate, a method for fabricating the same, and a touch panel. The touch substrate comprises a substrate which is provided with a first trench, and a first touch electrode is at least partially arranged in the first trench. By arranging the first touch electrode at least partially in the first trench, the difference in height due to the first touch electrode is reduced or eliminated, and adverse effects on films over the first touch electrode due to the difference in height are reduced or eliminated. For example, this facilitates alleviating the breaking of films over the first touch electrode due to a large difference in height, and reducing difficulties and risks in a film forming process. This facilitates reducing defects of a wiring due to climbing over a slope, for example an open circuit of a wiring or a short circuit between wirings in different layers. Moreover, a small difference in height facilitates avoiding scratches and defects related with electro static discharge (ESD), thus improving yield.

It is noted that the inventive concept of the present disclosure has been elucidated in the above embodiments by referring to a bridge type touch substrate. However, it is understood by the person with ordinary skill in the art that the above inventive concept is also applicable to a touch substrate of other type. For example, in an exemplary embodiment, the touch substrate comprises a first touch electrode and a second touch electrode which have an overlapping region, the first touch electrode comprises a plurality of first sub-electrodes which are arranged separately and at least one first conductive connection part, and the second touch electrode comprises a plurality of second sub-electrodes which are arranged separately and at least one second conductive connection part. In this embodiment, the plurality of first sub-electrodes and the plurality of second sub-electrodes are arranged in a same layer, two neighboring first sub-electrodes are electrically connected with each other in the overlapping region through the first conductive connection part, and two neighboring second sub-electrodes are electrically connected with each other in the overlapping region through the second conductive connection part. The inventive concept as described for the above touch substrate is also applicable to the touch substrate in this embodiment.

Unless otherwise defined, the technical or scientific terms used in the present invention shall have the general meanings understandable for those ordinarily skilled in the field of the present disclosure. The wordings such as “first”, “second” or similar used in the description and claims of the present invention shall not represent any order, number or importance, but are used for distinguishing different elements. Similarly, the words such as “an”, “a” or similar shall not represent limitation of numbers, but mean existence of at least one. The words “comprise”, “include” or similar indicate an element or article preceding these words shall contain elements or articles listed behind these words and equivalents thereto, and do not exclude the presence of elements or articles other than those listed. The phrases “upper”, “lower”, “left”, “right” and etc. shall be used only to represent relative positions, wherein, when the absolute position of the described object is changed, the relative positions may be changed accordingly.

Apparently, the person with ordinary skill in the art can make various modifications and variations to the present disclosure without departing from the spirit and the scope of the present disclosure. In this way, provided that these modifications and variations of the present disclosure belong to the scopes of the claims of the present disclosure and the equivalent technologies thereof, the present disclosure also intends to encompass these modifications and variations.

1. A touch substrate, comprising:
a substrate,
an insulating layer which is arranged on the substrate, and
a first touch electrode and a second touch electrode which are insulated from each other, are arranged on the substrate and have an overlapping region, wherein the first touch electrode and the second touch electrode are insulated from each other in the overlapping region through the insulating layer, wherein the substrate is provided with a first trench, and the first touch electrode is at least partially arranged in the first trench.

2. The touch substrate of claim 1, wherein:
the first touch electrode comprises at least one conductive connection part and a plurality of sub-electrodes which are separated from each other,
two neighboring sub-electrodes are electrically connected with each other through one of the conductive connection parts, and
the at least one conductive connection part is arranged in the overlapping region between the first touch electrode and the second touch electrode.

3. The touch substrate of claim 2, wherein:
the sub-electrode of the first touch electrode is at least partially arranged in the first trench.

4. The touch substrate of claim 2, wherein:
the substrate is further provided with a second trench, and
the second touch electrode is at least partially arranged in the second trench.

5. The touch substrate of claim 4, wherein:
the plurality of sub-electrodes of the first touch electrode are arranged in a same layer as the second touch electrode.

6. The touch substrate of claim 4, wherein:
the first trench has a depth which is no less than a thickness of the plurality of sub-electrodes of the first touch electrode.

7. The touch substrate of claim 4, wherein:
the second trench has a depth which is no less than a sum of a thickness of the second touch electrode and a thickness of the insulating layer.

8. The touch substrate of claim 4, wherein:
the first trench and the second trench have a same depth.

9. The touch substrate of claim 1, wherein:
the first trench is at least arranged in the overlapping region between the first touch electrode and the second touch electrode.

10. The touch substrate of claim 4, wherein:
the second trench is at least arranged in the overlapping region between the first touch electrode and the second touch electrode.

11. The touch substrate of claim 2, wherein:
the conductive connection part of the first touch electrode is at least partially arranged in the first trench.

12. The touch substrate of claim 11, wherein:
the first trench has a depth which is no less than a thickness of the conductive connection part of the first touch electrode.

13. The touch substrate of claim 11, wherein:
the first trench has a depth which is no less than a sum of a thickness of the conductive connection part of the first touch electrode and a thickness of the insulating layer.

14. The touch substrate of claim 2, wherein:
the first touch electrode and the second touch electrode comprise a transparent electrically conductive material, and
the insulating layer comprises a transparent insulating material.

15. A touch panel, comprising a first display substrate, a second display substrate, and a protection substrate which is arranged on a side of the second display substrate away from the first display substrate, wherein one of the second display substrate and the protection substrate comprises the touch substrate of claim 1.

16. A method for fabricating a touch substrate, comprising steps of:
forming a trench in a substrate;
forming a first touch electrode and an insulating material pattern on the substrate in this order, wherein the first touch electrode is at least partially arranged in the trench; and
forming a second touch electrode on the substrate, wherein the first touch electrode and the second touch electrode have an overlapping region and are insulated from each other in the overlapping region through the insulating material pattern.

17. The method of claim 16, wherein the step of forming the trench in the substrate comprises:
coating photoresist on the substrate, and forming a photoresist pattern by exposure and development; and
by using the photoresist pattern as a mask, forming the trench in the substrate by dry etching.

18. The method of claim 17, wherein the step of forming the first touch electrode and the insulating material pattern on the substrate in this order comprises:
forming an electrically conductive layer and an insulating layer on the substrate in this order;
patterning the insulating layer to form the insulating material pattern; and
removing the photoresist pattern and the electrically conductive layer on the photoresist pattern by using a peeling solution, to form the first touch electrode.
